(19) United States
(12) Patent Application Publication
(10) Pub. No.: US 2017/0161248 A1
(43) Pub. Date: Jun. 8, 2017

(54) System and Methods for Benefit Eligibility Verification

(71) Applicant: Lexmark International Technology, SA, Meyrin (CH)

(72) Inventor: Kristen Diane Parker, Lawrence, KS (US)

(21) Appl. No.: 14/984,123

(22) Filed: Dec. 30, 2015

Related U.S. Application Data
(63) Continuation of application No. 14/958,743, filed on Dec. 3, 2015.

(51) Int. Cl. G06F 17/24; G06Q 40/00; G06Q 50/26

(52) U.S. Cl. CPC G06F 17/243; G06Q 50/26; G06Q 40/12

(57) ABSTRACT

A method for determining by a server whether an owner of a document is eligible for one or more receivables that includes selecting, based on a regulation associated with the document, one or more fields of an electronic copy of the document; generating a form displaying the selected one or more fields; sending, based on the regulation, a notice of availability of the form to a mobile device; receiving, from the mobile device, updated one or more fields via the form; determining, based on the updated one or more fields and the regulation, whether the owner of the document is eligible for the one or more receivables; and upon a positive determination, sending a notice of eligibility to the owner via the mobile device.

### CROSS REFERENCES TO RELATED APPLICATIONS

This application is a continuation application of U.S. patent application Ser. No. 14/958,743, filed Dec. 3, 2015, entitled “System and Methods for Benefit Eligibility Verification,” the content of which is hereby incorporated by reference in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to benefit eligibility verification and, more particularly, to a system and methods for completing eligibility documentation using a mobile device.

2. Description of the Related Art

Receipt of certain social welfare benefits or assistance, such as food stamps and healthcare, involves the determination that an individual is qualified to receive such benefits or assistance, and such qualifications may be based upon the analysis of certain criteria or standards, such as household income or the number of dependents. Under such programs, recipients are required to report certain life events or changes that may affect their eligibility status and may be required to provide periodic verification of continued eligibility.

Traditionally, applicants and recipients have completed or filled-in physical hardcopy application or eligibility forms to apply and maintain their benefits. Applicants and recipients have typically acquired the hardcopy forms by visiting their local benefits office or agency, such as the local health and human services (HHS) department, or having the hardcopy forms mailed to them.

When the completed forms are submitted or returned to the benefits office, the data from such completed forms must then be keyed in by data entry personnel and/or the completed forms scanned and data extracted by software (e.g., optical character recognition software). The data and/or forms are then transmitted to database repositories for storage and future access. Some of the disadvantages of the process involving hardcopy forms are the overhead costs, such as printing forms (which may need to be updated from time to time), postage, transportation (which may be provided by some offices), and the labor associated with performing such activities. Additionally, errors associated with humans mistyping information or optical character recognition software incorrectly reading characters may occur.

With the coming of the digital age, physically going to the agency office or mailing the forms to the applicant/recipient is no longer required. A person can now access, such as via the Internet, and download digital forms. An applicant/recipient may then complete and sign the required form(s), then either mail or submit a scanned form electronically.

One of the shortcomings of this approach, however, is that a social welfare applicant or recipient may not have ready access to a computer or printing device. However, many social welfare applicants and recipients, have access to a mobile device, such as a smart phone, which offers access to the Internet.

Thus, what is needed is a system and method for completing an application or eligibility form to apply and maintain social welfare benefits using a mobile device.

### SUMMARY

The present disclosure is directed to completing electronic forms, and more particularly, to completing electronic forms for determining social benefits eligibility using mobile devices.

One example method for determining receivables eligibility by a server includes selecting, based on a regulation associated with the document, one or more fields of an electronic copy of the document; generating a form displaying the selected one or more fields; sending, based on the regulation, a notice of availability of the form to a mobile device; receiving, from the mobile device, updated one or more fields via the form; determining, based on the updated one or more fields and the regulation, whether the owner of the document is eligible for the one or more receivables; and upon a positive determination, sending a notice of eligibility to the owner via the mobile device.

A second example method for electronically verifying benefit eligibility includes generating an electronic benefit eligibility form from a plurality of database fields; providing the electronic benefit eligibility form to a mobile device for updating of the database fields by a user; receiving, from the mobile device via the electronic benefit eligibility form, updated data corresponding to the database fields; and replacing the plurality of database fields with the received updated data. The providing the electronic benefit eligibility form may include e-mailing or texting the user that the electronic benefit eligibility form is available for completion. The e-mail or text may further include a universal resource locator from which the electronic benefit eligibility form may be accessed by the user.

The example methods may further include verifying an identity of the user prior to the receiving the updated data corresponding to the database fields.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a block diagram of an example benefits eligibility system.

FIG. 2 is an example flow chart of one example method of facilitating benefits eligibility verification, as performed in the system of FIG. 1.

FIG. 3 is an example mobile device user interface displaying an eligibility form.

FIGS. 4-7 are example mobile device user interfaces according to some example embodiments.

Corresponding reference characters indicate corresponding parts through the several figures. The exemplifications set out herein illustrate example embodiments of the disclosure, and such exemplifications are not to be construed as limiting the scope of this disclosure in any manner.

### DETAILED DESCRIPTION

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams and flow charts, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams and flow charts discussed in detail in the description below.

These computer program instructions may also be stored in a non-transitory computer-readable storage medium or memory that may direct a computer or other programmable data processing apparatus to function in a particular manner, such that the instructions stored in the computer-readable storage medium or memory may produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks. The present disclosure is directed to facilitating information between a server and a mobile device so as to determine benefits eligibility of its user.

Accordingly, blocks of the diagrams support combinations of means for performing the specified functions, combinations of steps for performing the specified functions and program instruction means for performing the specified functions. It will also be understood that each block of the block diagrams, and combinations of blocks in the block diagrams, may be implemented by special purpose hardware-based computer systems that perform the specified functions, actions or steps, or combinations of special purpose hardware and computer instructions.

In addition, it should be understood that example embodiments of the disclosure include both hardware and electronic components or modules that, for purposes of discussion, may be illustrated and described as if the majority of the components were implemented solely in hardware. As such, it should be noted that a plurality of hardware and software-based devices may be utilized to implement the present disclosure.

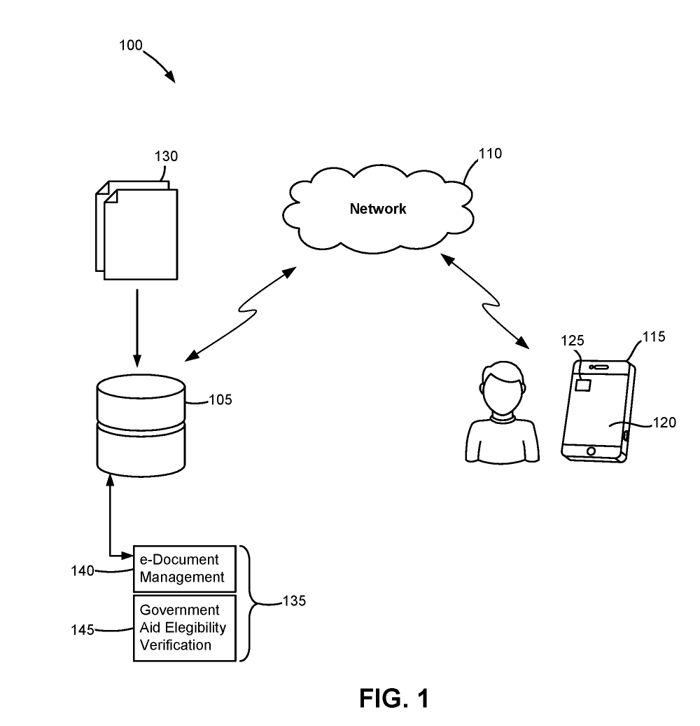

FIG. 1 is a block diagram of an example benefits eligibility system 100. Example system 100 includes a server 105 and one or more mobile devices 115 communicatively coupled or connected via a network 110. Server 105 may be any computing device, including, but not limited to, a personal computer, a server computer, a series of server computers, a mini computer, a mainframe computer, a web server or a series of web servers.

Network 110 may include a variety of software, such as an “app store” for a mobile application, and a variety of hardware such as routers, servers, switches, desktop or laptop computers, phone transmission towers, satellites, and other like hardware equipment. The network connection typifies wired communications, wireless communications (e.g., in transmission towers and satellites) or a combination of both in an internet (e.g., for a web server), an intranet, or other environment. Each mobile device 115 is a computing device that is portable, handheld, pocket-sized or the like, such as a cellular phone, tablet computer or other mobile device.

As shown in FIG. 1, mobile device 115 may include a user interface or touch screen display 120 onto which data may be directly entered. Mobile device 115 may also include telephony technology to make and receive phone calls, a camera for taking pictures or recording videos, and/or a signature reader (e.g., a signature panel or a fingerprint scanner/button) for authenticating and/or authorizing users to use mobile device 115.

In some alternate example embodiments, mobile device 115 may have a user interface for displaying information and a physical or virtual keypad for inputting data into mobile device 115.

Mobile device 115 includes at least one mobile application 125. Mobile application 125 may be launched and run by selecting or pressing an icon, label or other indicator displayed on touch screen 120 which represents mobile application 125. Mobile application 125 may be, for example, an application, a web browser, a voice messaging service, a text messaging service (e.g., SMS) and the like. Examples of mobile devices include smartphones, cellphones, tablet computers, mobile navigation devices, enterprise digital assistants, pagers, and the like.

In the example embodiment of FIG. 1, network 110 allows server 105 to provide content to mobile device 115 and vice versa. As shown in FIG. 1, server 105 hosts and/or provides content such as, for example, copies of forms 130, electronic forms and information or data associated with forms 130. Initially, server 105 stores electronic copies of forms 130. In this example embodiment, forms 130 are printed and/or electronic forms from an agency. An agency includes a government agency, a public charity, a private enterprise giving benefits, or any like organization providing receivables, loans, job or other opportunities to individuals. Each corresponding form 130 includes data associating an owner (i.e., individual), which may be expressed by a name, number or other identifier, etc., as a recipient or continuing recipient of receivables and/or for storage of information pertaining to the owner. For example, the data in form 130 may include the recipient's income statement, household status, number of dependents, child support status and the like as dynamic fields (i.e., fields that may be changed by an owner or agency administrator). Form 130 also includes contact details such as, for example, an email address of the actual or potential benefits recipient or owner of the form to be completed or updated and his or her mobile device number, which may be used identify mobile device 115 and associate the owner to such mobile device 115. In addition, forms 130 may include static fields, such as a date of birth, name(s) of parent(s) and birthplace of the owner, which do not change over time.

Server 105 may include one or more applications 135 to manage forms 130 and determine the eligibility of owners to receive benefits. In the example embodiment of FIG. 1, application(s) 135 include modules such as, for example, an electronic document (e-Doc) management module 140 for managing and updating the copies of forms 130 and an verification module 145 for determining what benefits, if any, to provide owners. The manner in which the server application(s) create, store and/or update electronic copies of forms 130 will now be described in detail.

e-Doc management module 140 requires one or more categorization tools to automate the placement of data from forms 130 to server 105. In one such example embodiment, paper versions of forms 130 generally enter e-Doc management module 140 through a scanner or a multi-function printer (MFP). Imaging software on the scanner or MFP captures images of forms 130. In some example embodiments, forms 130 are typically ingested into server 105 as “structured” data using well-known archive services (e.g., ECM or Enterprise Content Management) in the process performed by e-Doc management module 140. In some other example embodiments, unstructured forms with no pre-defined template may be refined and still received as “structured” data.

In well-known recognition technologies used by e-Doc management module 140, data from each form 130 may even be translated to electronic data without manual data input. For example, form 130 (e.g., text, characters, picture image(s)) may be immediately recognized, converted into data, entered in a corresponding electronic version of form 130 and stored in server 105. An optical character recognition (OCR) or intelligent character recognition (ICR) technology in e-Doc management module 140 converts large amounts of data or unstructured data to usable data. Examples of usable data include, but are not limited to, one or more fields of a corresponding section in form 130 that are necessary for the creation, completion and/or updating of form 130.

In records management of server 105, the updated form is stored in a repository or storage. As well known in the art, a repository may be a sophisticated ECM file system or a simple file folder system. The key is to have data retrievable once placed in server 105, and in particular, in e-Doc management module 140. In the example embodiment of FIG. 1, application(s) 135 may include a storage medium for temporary or permanent storage of usable data in modules 140, 145. The storage medium may include, for example, optical disks, magnetic tape, microfilm, redundant array of independent disks (RAID), paper, and the like media. In the latter, the data is printed on sheets of media. However, electronic copies may have the same legal status (e.g., authenticity and enforceability) as the printed media itself. In one example embodiment, server 105 stores the data online for rapid access such as, for example, over the public Internet via e-Doc management module 140. In another example embodiment, e-Doc management module 140 provides associated web links to the public Internet, thereby allowing quick accesses to stored data. In some example embodiments, where the updated form is first stored in e-Doc management module 140, another automated data entry into eligibility verification module 145 may be necessary for determining eligibility.

In the example embodiment shown in FIG. 1, server application(s) 135 store an updated list of private, state and/or federal regulations and the like commands to determine eligibility. In one example embodiment, the commands are stored in module 145. In addition or in the alternative, the commands are stored in module 140. Alternatively, the commands may be linked to/referenced from the public Internet or an external memory such as, for example, a server separate from server 105. In such an alternative example embodiment, each module 140, 145 uses a web link to the commands stored in another server or the internet. The regulations/commands are associated with the agency, the recipients and/or the receivables. Generally, e-Doc management module 140 and/or, preferably, eligibility verification module 145 determines whether the benefits recipient needs to provide updates to forms 130 based on the commands For example in FIG. 1, in a government agency, eligibility verification module 145 is shown as a government aid eligibility verification 28 for determining eligibility based at least in part on commands associated with government aid. In addition or in the alternative, information regarding the owner is stored and then used to populate form 130. This then results in an updated form 130 in alignment with the commands.

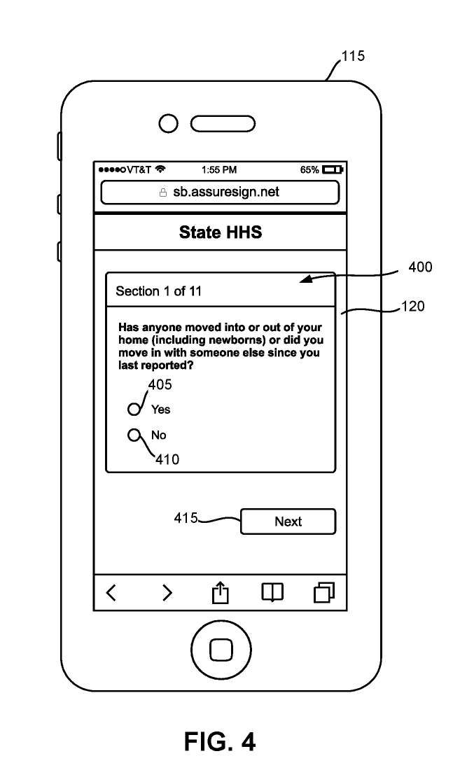

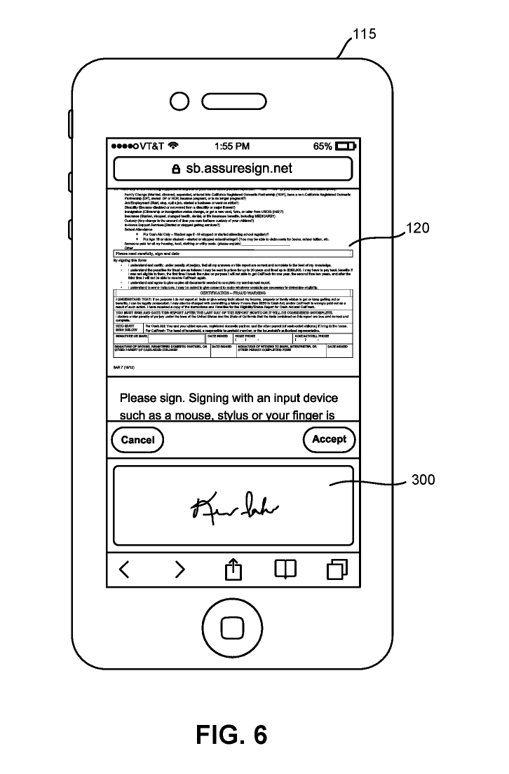

As illustrated in FIGS. 4 and 6, mobile device 115 also includes a plurality of buttons 31 displayed on its user interface 120 to navigate through the operating system of mobile device 115. In this example embodiment of FIG. 1, mobile device 115 has access to a mobile application 125 via the plurality of buttons 31 or the touch screen 18, such as for example to run and then navigate through the mobile application 125. In FIG. 1, an icon is displayed on touch screen 18 for launching mobile application 125. The mobile application 125 may be, for example, an application, a web browser, a voice messaging service, a text messaging service (e.g. SMS) and the like. Processes and required actions in mobile device 115 to download files for mobile application 125 via network 110 are known in the art.

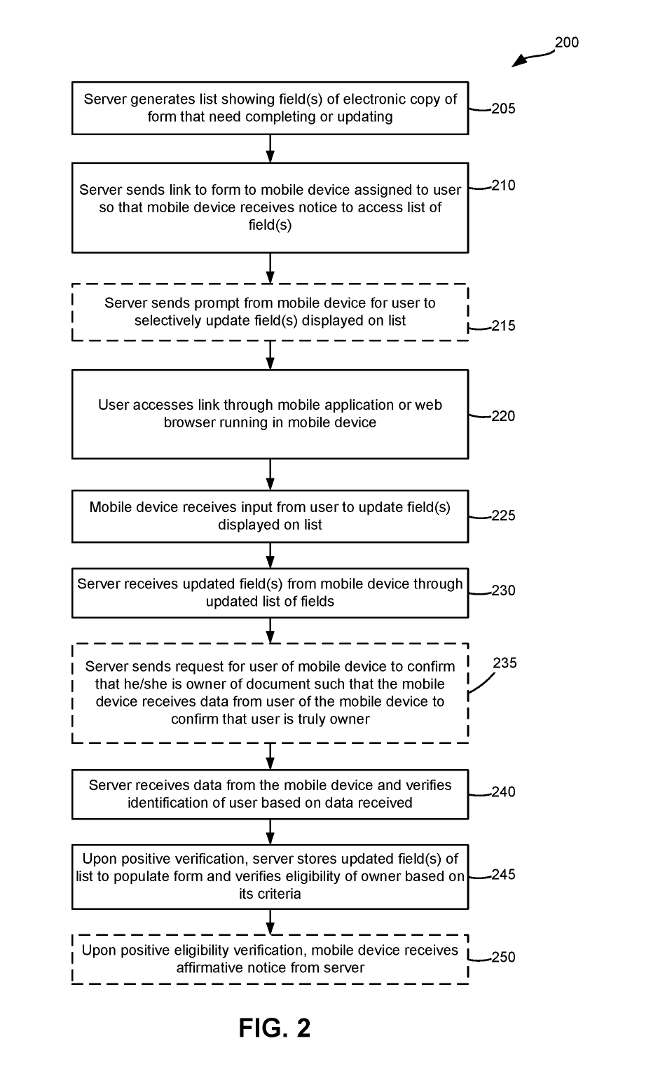

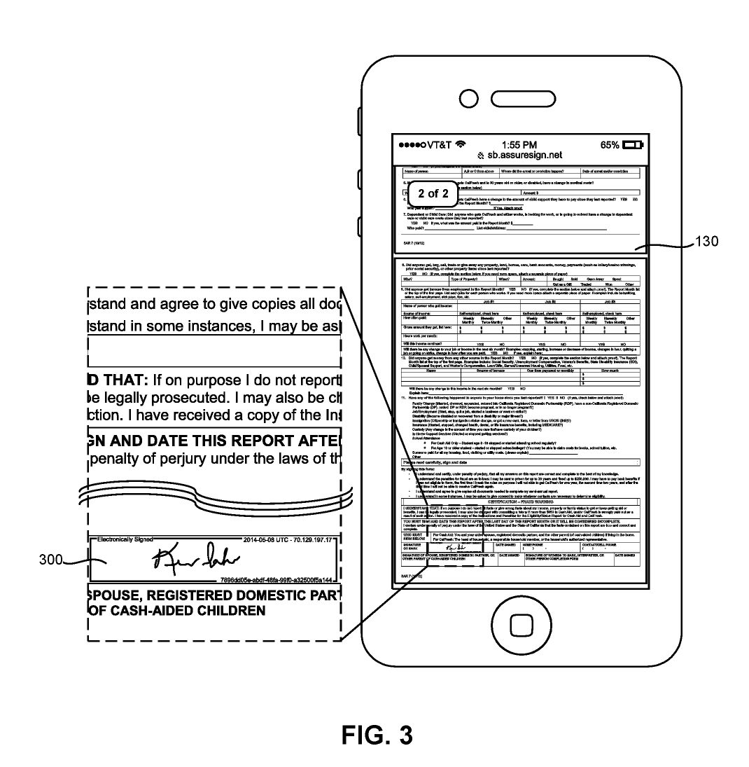

With reference still to FIG. 1, mobile application 125 runs on one or more mobile devices 115 to provide communication with server 105. In addition or in the alternative, web links distinct from the icon may be shown on the touch screen—for example, in the case of mobile application 125, using a web browser. FIG. 2 illustrates an example flow chart of one example method 200 for facilitating communication between server 105 and mobile device 115 using mobile application 125. At block 205, server 105 generates an electronic list of fields from form 130 (see, e.g., FIG. 3) that need completed, reviewed, or updated based at least in part upon the above commands Generally, e-Doc management module 140 and/or eligibility verification module 145 create the list of fields by creating questions or, in addition, possible answers that both correspond to each field (see, e.g., FIGS. 4-6 which show various fields of form 130). In this example embodiment, the list of fields displays one or more sections having corresponding field(s) thereon derived from the field(s) of example form 130. A field on each section of the list of fields corresponds to a request, which cannot be edited on the list of fields, and a response that should be edited thereon. Each request and response is, for instance, a text message (MMS/SMS), an email message, an interactive display or the like function of application 125.

At block 210 in FIG. 2, server 105 sends a universal resource locator (URL) link to the list of fields onto mobile device 115 that is assigned to an owner of form 130. In this example embodiment, at least a portion of form 130 (i.e., the one or more fields) is now available for the review, completion and/or update. In one example embodiment, the link is sent by server 105 via mobile application 125 each time eligibility verification is required. In another example embodiment, the link is sent at predetermined dates and/or times based at least in part upon the commands stored in server 105. For example, e-Doc management module 140 and/or eligibility verification eligibility verification module 145 sends a web link to mobile device 115 based on the government aid regulations. FIGS. 4-6 each illustrate a graphical representation of user interface 120 showing the list of fields via an interactive display or touch screen. In addition or in the alternative, mobile device 115 receives from server 105 a notice to access the list of fields via this web link. In one example embodiment, the notice includes the web or URL link to the list of fields. For example, the notice may be an email or text message (SMS) with “sb.assuresign.net” in its message block and/or subject header. This results to the notice and link being received by mobile device 115 simultaneously. In another example embodiment, the notice includes another web link (e.g., a bookmarklet) to, for example, a downloadable application for completing the list of fields. In yet another example embodiment, the notice indicates a looming deadline for submitting an updated list of fields. In still yet another example embodiment, the notice does not include any link, much less a web link or a bookmarklet. For example, the notice may simply state that there is a deadline to access form 130 via mobile application 125 and, in addition or in the alternative, prompt an action by the user or owner (optional block 215 of FIG. 2).

For example, server 105 may receive a prompt from mobile device 115 to update the one or more fields of the list of fields to be displayed on mobile device 115. The prompt may be, but is not limited to, an e-mail or SMS, as well as a push notification from mobile device 115. In one example embodiment, the prompt may include an option for a user of mobile device 115 to select how to populate blank fields of form 130. In particular, the user may elect to populate the blank fields all at once or, in the alternative, select to do so one at a time.

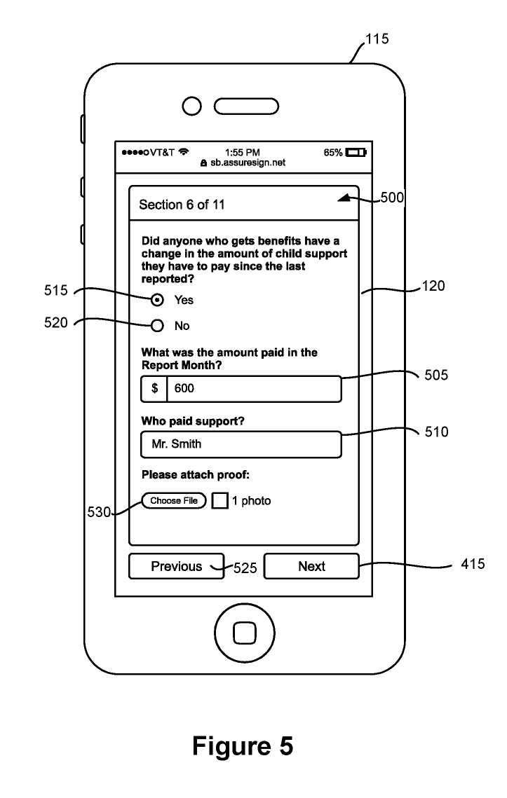

In FIG. 2, at block 220 the user of mobile device 115 accesses the link to the list of fields through mobile application 125 on user interface 120 such that server 105 grants mobile device 115 access to the list of fields. Returning to FIG. 4, user interface 120 shows a first section (i.e., Section 1) 400 of the list of fields. In user interface 120, section 400 shows a blank/unanswered field. In this example embodiment, the blank field of section 400 is displayed as radial button selectors 405, 410 for responding to a request for the user of mobile device 115 to indicate whether a change in household status has occurred. In particular, the user is requested to select either a “Yes” selector 405 or a “No” selector 410 in response to the question “Has anyone has moved into or out of the your own home (including any newborns) or did you move in with someone else since you last reported?” to indicate whether a change in living arrangements has occurred since a last submission of the report. In another example embodiment, other preset or pre-populated selectors or options may be used such as, for example, a drop down menu or a check box. In still other example embodiments, the one or more fields may be free form text boxes so that a user or owner can enter type in the desired data. In yet another example embodiments, the sections may show the one or more fields already prepopulated with previously stored data from server 105, such as for example in a sixth section 500 shown in FIG. 5. For example, a field 505 labeled “What was the amount paid in the Report Month?” and a field 510 labeled “Who paid support?” may be prepopulated with the data previously provided by the owner, such as during the initial application or a previous verification.”

In FIG. 5, the completed fields in section 500 may be alterable by the user of mobile device 115. In the example embodiments of FIGS. 4 and 5, a “Next” block 415, when pressed or activated, allows user interface 120 to proceed to the next field(s) and/or other sections of the list of fields. In FIG. 5, another block 525 labeled as “Previous” is provided to allow an owner or user to return to or edit previous sections of the list of fields such as, for example, a fifth section (not shown). In an alternative example embodiment, there is only one section that displays the entire list of fields on user interface 30. This way, the list is answered on one display of user interface 125, and there is no need to move from one section to the next. Moreover, this allows the owner to be provided with a single complete form to fill in and has the same look and feel as original form 130 (as seen in FIG. 2) so the user more readily recognizes form 130. In yet another example embodiment, the one or more fields are directed to or include only those pertaining to the one or more fields of form 130 which need to be updated and not the fields that do not need updating, such as for example, the static fields. In such embodiments, the list of selected fields fits on user interface 120 in only one section (versus a two-page or plural-section form 130).

Returning to FIG. 2, at block 225 mobile device 115 receives new data as input from its user to send updated one or more fields to server 105. In the example embodiment of FIGS. 4 and 5, the user of mobile device 115 chooses between respective “Yes” and “No” buttons 405, 410 and 515, 520 and selects a “Next” block 415 to automatically save his/her response to an updated list on mobile device 115. For example, one of buttons 405 and 410 in FIG. 4 is selected while one of buttons 515 and 520 in FIG. 5 is selected for a “Yes” or “No” response to their respective fields. In the example embodiment of FIGS. 4 and 5, the responses (i.e., new data) to corresponding fields in section 500 are saved at the same time in the interactive display when, for instance, the “Next” block 415 is selected or pressed. In FIG. 5, the selection of “Previous” block 525 returns user interface 120 back to section 5 (not shown) so the owner or user can edit what had been previously saved in mobile device 115. In one example embodiment, a simple “Yes” or “No” response (not shown) by a user of mobile device 115 into an email or SMS text block may be at least partly sufficient to input the new data.

With reference still to FIGS. 4 and 5, each field such as, for instance, in respective sections 400 and 500, may be responded to—and so inputted—one at a time. For example, in the case of the text message or SMS/MMS, the new data is stored in server 105 one at a time. In particular, when mobile device 115 receives an email or text message asking if anyone who gets benefits has had a change in the amount of child support that they have to pay since last reported similar to the “Yes” or “No” or first field in section 6 (FIG. 4), only a “Yes” or “No” response back from the user or owner is deemed necessary. Additionally, when mobile device 115 receives a message requesting for the amount paid in the Report Month and a request for the name of the person who paid for support (similar to the second and third fields 505 and 510 in section 500 of FIG. 5), the same or another response may be used to indicate the amount and the name of the person. Likewise, a received message asking for proof may be responded to using the same email or text message thread as the “Yes” or “No” requests and/or the amount and person's name so as to populate form 130 one at a time in server 105. As later described in detail, the proof may be sent as an attachment. Alternatively, a plurality of responses may be performed all at the same time (similar to the saving of data), thereby sending the list of fields as one file for more file fidelity when populating form 130. After or during the user inputting the new data on the list of fields, mobile device 115 sends the updated one or more fields to server 105. Because the user or benefits recipient completes the list of fields electronically, there is reduced labor for requesting updates and/or adding forms 130 to e-Doc management module 140, reduced hard costs (e.g., for paper and postage), and no more labor for manual data input in one or more offices of an agency responsible for forms 130.

Returning again to FIG. 2, at block 230, server 105 receives the updated field(s) from the mobile device 115 via the electronically updated list of fields. Referring to FIG. 5, in one example embodiment, section 500 of the list of fields is either already completed by the user or showing data directly from scanned form 130 that may or may not need to be updated. In this example embodiment, the form owner (i.e., recipient of receivables from the agency) has the ability to check or review his/her completed list of fields, thereby ensuring the correct list of fields is received by server 105 of the agency. The population of form 130 in server 105 after the reception of the list of fields from mobile device 115 is based on the selection, for example, in the prompt received by mobile device 115. As discussed above, the one or more fields of form 130 is filled up either one at a time (e.g., SMS) or all at once so that populating of form 130 in server 105 is respectively done one at a time as mobile device 115 moves from one section to the next, or all at once after all the section(s) have been completed.

Optionally at block 235 in FIG. 2, server 105 sends a request for the user of mobile device 115 to confirm that the user is the owner of form 130. For example, the user may be prompted to sign the list of fields using an electronic signature technology (see, for example, FIGS. 3 and 6) on mobile device 115 for identity check of the owner using records from the agency. In previous example embodiments, user interface 120 may optionally request for the user of mobile device 115 to sign and/or verify the user's identity as the owner of the copy of form 130 to be updated. In one example embodiment, this request is performed after the sections (e.g., sections 1-11) and associated fields are filled. Alternatively, the request for a user or owner to confirm his/her identity may be sent before the sections of the list of fields are displayed on user interface 30. This ensures that no data such as, for example, in the case of section 500 shown in FIG. 5, is ever exposed. For instance, such exposure would be undesirable if a current user of the mobile device 115 were not the owner of form 130. In still an alternative example embodiment, the user is verified as the owner only after the form 130 in server 105 has been completed. A positive verification results in an automatic saving of form 130 in server 105.

In one example embodiment, user data may include one or more static fields of form 130. In an alternative example embodiment, as shown in FIG. 6, the user verification is by means of his/her signature entered via a signature panel 34 of mobile device 115. In FIG. 3 there is shown the signature automatically populated onto the electronic form 130 similar to how the other fields of the form are populated. In this example embodiment, signature field 300 is the first to be populated in order to verify the identity of the user of mobile device 115 before proceeding to update or populate other fields of form 130. This allows for form 130 to editable only when the identity of the user of mobile device 115 has been verified as the owner of form 130. In addition or in the alternative, this allows for the populating of the fields of form 130 to be done one at a time so information is automatically stored into server 105 after each part such as, for example, each section 400, 500 is updated.

Other means of verifying identity may also be used such as, for example but not limited to, a fingerprint and/or a voice recognition system. As is well known in the art, the restriction of access to data during its creation, management and delivery may be provided in mobile device 115 with digital signature/s that ensure the identity of a document sender (e.g., mobile device user) and the authenticity of the message. In addition, better security may be provided with a private key infrastructure that uses a public and private key pair in mobile device 115 and held by a trusted third party (e.g., server 105) so as to transact business over the public Internet via mobile application 125. Also, digital rights management in server 105 may prevent the illegal distribution of rights-managed data of the owner of form 130 by granting or restricting forwarding and accessing thereof (e.g., via mobile application 125).

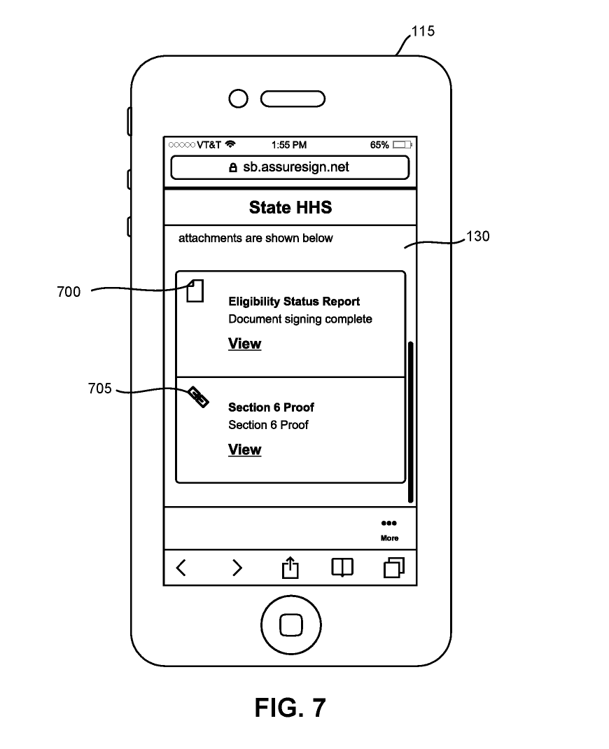

At block 240 in FIG. 2, server 105 receives the new data from mobile device 115 and verifies the user thereof based at least in part upon the received new data. As described in the previous example embodiments, this new data may or may not include user data for identity confirmation. In one example embodiment, the user verification is based on the new data and/or attached proof. (See, e.g., FIGS. 5 and 7). In another example embodiment, the populating of the signature field is done only after the other fields of form 130 are already populated. In addition or in the alternative, information regarding the owner used to populate form 130 only if, for example, the signature (see FIG. 6) is verified as that of the owner of form 130. This then results in an updated form 130 in server 105.

FIG. 7 illustrates user interface 120 showing a summary of attachments for the updated list of fields and for proving the new data provided. In one example embodiment, these attachment(s) are available for update only after field(s) of each section of the list of fields has been completed by the user (see FIG. 5). In the example embodiment of FIG. 7, an optional thumbnail 700 is an eligibility tab, e.g., “Eligibility Status Report”. The eligibility tab displays the user (still) being eligible to benefits and/or the user having signed the list of fields (FIG. 6). For example, clicking on the “View” link brings the user of mobile device 115 to the eligibility report for mobile device 115. In one example embodiment in FIG. 7, optional thumbnail 700 supports “Documents signing” such as, for example, the signature panel 300 in FIG. 6, which must be identified as “complete” to be able to view or receive eligibility status.

With reference still to the example embodiment shown in FIG. 7, another thumbnail 705 is a proof tab showing an attachment for the user to submit or resubmit as proof of the one or more fields already filled or are about to be filled. This attachment, shown as a diagonal symbol inside proof tab 705 in FIG. 7, is a proof of the data provided. In this example embodiment of FIG. 7, the attachment such as, for example, a child support status photo, for a “Section 6 Proof” is displayed on the last or third field 530 of section 500 (see FIG. 5). Alternatively, the proof may even correspond to data provided in another section (e.g., household status). In one example embodiment, any signing and/or attachment for proof(s) is completed prior to updating section 1 onwards for the above described security reasons. For example, the attachment(s) may be available for upload before the fields are even sent to mobile device 115. In an alternative example embodiment, the signing and/or attachment for proof is done after the fields of the list of fields are filled. In an alternative example embodiment, clicking on the “View” link brings the user of mobile device 115 to have the proof submitted displayed on user interface 30.

Finally returning to FIG. 2, at block 245 server 105 stores the updated field(s) and verifies eligibility based on its criteria. In this example embodiment, eligibility verification module 145 uses the new data from the updated one or more fields as one of the criteria. In addition or the alternative, the criteria may include, but not be limited to, the commands or state regulations as well as the user data—most of which remain static data. In one example embodiment, the updated list of fields is already stored in server 105 before determining if any change in benefits, if any, is required. This availability of the updated list of fields for the Agency is done at least in part by the automated data entry into e-Doc management module 140. The copy of form 130 may be replaced with an updated copy showing the updated fields, or another separate copy of form 130 having the updated fields may be created and/or stored in server 105 by e-Doc management module 140. In particular, in this example embodiment, after receiving the new data from mobile device 115, the server 105 (in particular e-Doc management module 140) stores the new data of the list. In one example embodiment, eligibility verification eligibility verification module 145 receives the new data for the list of fields from server 105 and/or e-Doc management module 140 for data entry. This provides one backup copy of the updated list of fields. In another example embodiment, eligibility verification module 145 reads the updated list of fields stored in e-Doc management e-Doc management module 140 and verifies eligibility using the commands. This ensures that the benefits recipients do not have their list of fields stored twice in server 105, taking up additional storage space before benefits eligibility is verified.

Thereafter, at optional block 250 upon the positive verification by eligibility verification eligibility verification module 145, mobile device 115 receives a notice indicating a positive verification. For example, the notice may be a “Yes” email or text message from server 105. Also, the notice may be a voice mail, a chat message (e.g., snap chat) or the like showing that the owner of form 130 is (still) eligible. As discussed above, the “View” link in the Eligibility Status Report thumbnail 700 brings the user of mobile device 115 to the eligibility determination results. In the case of a benefits recipient, upon a positive eligibility of the owner of form 130 as entitled to receivables or benefits, for example, may be provided by means of food stamps, renewed subscriptions, work assistance, disability assistance, child support, freebies and the like provisions by the Agency. In other areas, such as for example, typical filling up of a job application form, the receivable is a filled-up form that has been approved for an interview by the hiring company.

It will be appreciated that the actions described and shown in the example flowchart may be carried out or performed in any suitable order. It will also be appreciated that not all of the steps described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific example embodiments disclosed and that modifications and other example embodiments are intended to be included within the scope of the appended claims. Although specific terms are employed herein, they are used in a generic and descriptive sense only and not for purposes of limitation.

What is claimed is:

1. A method for determining by a server whether an owner of a document is eligible for one or more receivables, the method comprising:
selecting, based on a regulation associated with the document, one or more fields of an electronic copy of the document;
generating a form displaying the selected one or more fields;
sending, based on the regulation, a notice of availability of the form to a mobile device;
receiving, from the mobile device, updated one or more fields via the form;
determining, based on the updated one or more fields and the regulation, whether the owner of the document is eligible for the one or more receivables; and
upon a positive determination, sending a notice of eligibility to the owner via the mobile device.

2. The method of claim 1, wherein the one or more fields displayed on the form corresponds to at least one of a static and a dynamic field of the electronic copy.

3. The method of claim 1, wherein the sending the notice of availability of the form to the mobile device includes sending the notice of availability and one of the form and a link to the form attached to the notice.

4. The method of claim 1, further comprising identifying the mobile device as a mobile device assigned to the owner of the document based on a field of the electronic copy.

5. The method of claim 1, further comprising confirming, based on data associated with the owner, whether a user of the mobile device is authorized to update the one or more fields via the form, upon a positive confirmation, performing the receiving the updated one or more fields.

6. The method of claim 5, wherein the data includes at least one of an email address, an ID number and a digital signature from the user.

7. A method for electronically verifying benefit eligibility, comprising:
generating an electronic benefit eligibility form from a plurality of database fields;
providing the electronic benefit eligibility form to a mobile device for updating of the database fields by a user;
receiving, from the mobile device via the electronic benefit eligibility form, updated data corresponding to the database fields; and
replacing the plurality of database fields with the received updated data.

8. The method of claim 7, wherein the providing the electronic benefit eligibility form comprises e-mailing the user that the electronic benefit eligibility form is available for completion.

9. The method of claim 8, wherein the e-mailing includes e-mailing a universal resource locator from which the electronic benefit eligibility form may be accessed by the user.

10. The method of claim 7, wherein the providing the electronic benefit eligibility form comprises texting the user that the electronic benefit eligibility form is available for completion.

11. The method of claim 10, wherein the texting includes an active link to access the electronic benefit eligibility form.

12. The method of claim 7, wherein the replacing the plurality of the database fields occurs automatically without manual data entry.

13. The method of claim 7, wherein one of the plurality of database fields is a household income field.

14. The method of claim 7, wherein one of the plurality of database fields is a number of dependents field.

15. The method of claim 7, further comprising verifying an identity of the user prior to the receiving the updated data corresponding to the database fields.

16. One or more computer readable memories containing a computer program that is executable by a processor to perform a method of determining user eligibility for a receivable, the method comprising:
generating a form containing the one or more fields, the one or more fields associated with a criteria of a regulation;
sending, based on the regulation, a notice of availability of the form to a mobile device;
displaying the one or more fields to a user of the mobile device for updating by the user;
receiving, from the mobile device, updated data corresponding to the one or more fields;
determining, based on the updated data and the regulation, whether the user is eligible for the one or more receivables; and
upon a positive determination, sending a notice of eligibility to the user via the mobile device.

17. The one or more computer readable memories of claim 16, wherein the positive determination comprises confirming that the received updated data meets a criteria of the regulation.

18. The one or more computer readable memories of claim 17, wherein the criteria of the regulation comprises a household income.

19. The one or more computer readable memories of claim 17, wherein the criteria of the regulation comprises a number of dependents.

20. The one or more computer readable memories of claim 16, wherein the method further comprises verifying an identity of the user prior to the receiving, from the mobile device, the updated data corresponding to the one or more fields.
